(19) United States
(12) Patent Application Publication
(10) Pub. No.: US 2011/0230330 A1
(43) Pub. Date: Sep. 22, 2011

(54) DIELECTRIC MATERIAL FOR PLASMA DISPLAY PANEL AND GLASS PLATE FOR PLASMA DISPLAY PANEL

(75) Inventors: Kumiko Kondo, Otsu-shi (JP); Yoshiro Kitamura, Otsu-shi (JP); Hiroyuki Oshita, Otsu-shi (JP); Hiroshi Oshima, Otsu-shi (JP); Haruka Taniguchi, Otsu-shi (JP)

(73) Assignee: NIPPON ELECTRIC GLASS CO., LTD., Otsu-shi, Shiga (JP)

(21) Appl. No.: 13/129,401

(22) PCT Filed: Oct. 14, 2009
(86) PCT No.: PCT/JP2009/005354

§ 371 Date: May 16, 2011

(30) Foreign Application Priority Data
Dec. 9, 2008 (JP) 2008-313281

(51) Int. Cl. C03C 3/089; C03C 3/095

(52) U.S. Cl. 501/64; 501/65

(57) ABSTRACT

The invention provides a dielectric material for a plasma display panel which can be fired at a low temperature, is less likely to cause warpage in a glass substrate when fired on the glass substrate and can increase the strength of the glass substrate when fired on the glass substrate, and a glass plate for a plasma display panel including a dielectric layer formed using the dielectric material. The dielectric material for a plasma display panel contains ZnO—B₂O₂—SiO₂-based glass powder, and the glass powder contains substantially no PbO and contains, by mole percent, 1% to 20% (both inclusive) ZnO, 26% to 50% (both inclusive) B₂O₂, 42% (exclusive) to 50% (inclusive) SiO₂, and 0.1% to 5% (both inclusive) Bi₂O₂.

### TECHNICAL FIELD

This invention relates to a dielectric material for a plasma display panel and a glass plate for a plasma display panel including a dielectric layer formed of the dielectric material.

### BACKGROUND ART

Plasma displays are self-luminous flat panel displays. Plasma display panels have excellent characteristics, such as light weight, thin screen and wide viewing angles. In addition, plasma display panels can provide larger screens. Therefore, the plasma display panel market is rapidly growing.

A plasma display panel has a front glass substrate and a rear glass substrate which are opposed to each other. The front and rear glass substrates are hermetically sealed at their peripheries with sealing glass. A protective plate for protecting the front glass substrate is attached to the outside surface of the front glass substrate. A color filter is attached onto the protective plate. Furthermore, the interior of the panel is filled with rare gas, such as Ne or Xe.

The front glass substrate used in the plasma display panel has scan electrodes for plasma discharge formed thereon. On the scan electrodes, a dielectric layer (transparent dielectric layer) having a thickness of about 10 μm to about 40 μm is formed in order to protect the scan electrodes.

On the other hand, the rear glass substrate has address electrodes formed thereon to address the location of plasma discharge. On the address electrodes, a dielectric layer (address electrode-protecting dielectric layer) having a thickness of about 10 μm to about 20 μm is formed in order to protect the address electrodes. Further on the address electrode-protecting dielectric layer, partitions are formed for partitioning discharge cells. The inner surface of each cell is coated with red (R), green (G) or blue (B) phosphor. The plasma display panel has a mechanism in which the phosphors fluoresce when excited by ultraviolet rays generated by plasma discharge.

Generally, soda-lime glass or high-strain-point glass is used for the front and rear glass substrates of the plasma display panel. The scan electrodes and address electrodes are generally formed of Ag, which is inexpensive, or a Cr/Cu/Cr film laminate. In forming a dielectric layer on a glass substrate with electrodes formed thereon, a method is employed in which a dielectric layer is formed by firing a material in a relatively low temperature range of about 500° C. to about 600° C. in order to prevent deformation of the glass substrate and suppress degradation in characteristics due to reaction with the electrodes. Therefore, the dielectric material for forming a dielectric layer is required to have a coefficient of thermal expansion near to that of the glass substrate, be able to be fired in a relatively low temperature range of about 500° C. to about 600° C. and be unreactive with the electrodes.

The transparent dielectric layer is further required to have high transparency in addition to the above characteristics. Therefore, the dielectric material for forming a transparent dielectric layer is further required to be easily debubbled during firing.

Heretofore, dielectric materials containing PbO—B₂O₃—SiO₂-based lead glass powder, as for example described in Patent Literature 1, have been used as the materials meeting the above required characteristics. However, with recent increasing awareness of environmental protection and growing movement towards reduction of use of substances of environmental concern, the use of lead glasses is becoming reduced. Thus, work is proceeding with glasses satisfying the above required characteristics except lead glasses. At present, there are proposed dielectric materials containing ZnO—B₂O₃—SiO₂-based nonlead glass powder, as for example described in Patent Literature 2.

### CITATION LIST

### Patent Literature

Patent Literature 1: Published Japanese Patent Application No. H11-60272
Patent Literature 2: Published Japanese Patent Application No. 2008-60064

### SUMMARY OF INVENTION

### Technical Problem

Meanwhile, plasma display panels are required to be further thinned. For this reason, it is being considered to eliminate the protective plate for protecting the front glass substrate. However, if the protective plate is eliminated, the strength of the front glass substrate is lowered. Thus, when an impact is given to the front glass substrate, the front glass substrate may be easily broken.

In order to maintain the strength of the glass substrate even with no protective plate, it can be considered to form on the glass substrate a dielectric layer having a coefficient of thermal expansion lower than that of the glass substrate by 10×10⁻⁷/° C. or more. In this case, a compressive stress applied by the dielectric layer increases the strength of the glass substrate. However, in this method, a problem arises in that during firing of a dielectric material, the glass substrate may be warped.

An object of the present invention is to provide a dielectric material for a plasma display panel which can be fired at a low temperature, for example, 600° C. or below, is less likely to cause warpage in a glass substrate when fired on the glass substrate and can increase the strength of the glass substrate when fired on the glass substrate, and a glass plate for a plasma display panel including a dielectric layer formed of the dielectric material.

### Solution to Problem

Various experiments performed by the inventors have revealed the following findings (1) and (2), and based on these findings the present invention has been accomplished:

(1) If Bi₂O₂ is added to a ZnO—B₂O₂—SiO₂-based nonlead glass contained in a dielectric material for a plasma display panel to increase the contents of B₂O₃ and SiO₂, the dielectric material for a plasma display panel can be fired at a low temperature, for example, 600° C. or below.

(2) In addition, with the use of the above dielectric material for a plasma display panel, a high-strength dielectric layer can be formed on a glass substrate. Thus, a high-strength glass plate for a plasma display panel can be obtained.

Specifically, a dielectric material for a plasma display panel according to the present invention relates to a dielectric material for a plasma display panel containing ZnO—B₂O₂—SiO₂-based glass powder. In the present invention, the glass powder contains substantially no PbO and contains, by mole percent, 1% to 20% (both inclusive) ZnO, 26% to 50% (both inclusive) B₂O₂, 42% (exclusive) to 50% (inclusive) SiO₂, and 0.1% to 5% (both inclusive) Bi₂O₂.

Furthermore, a glass plate for a plasma display panel according to the present invention includes a dielectric layer formed of the dielectric material for a plasma display panel according to the present invention.

### Advantageous Effects of Invention

The dielectric material for a plasma display panel according to the present invention can be fired at a low temperature, for example, at 600° C. or below. When the dielectric material for a plasma display panel according to the present invention is fired on a glass substrate, the glass substrate is less likely to cause warpage. When a dielectric layer is formed on the glass substrate using the dielectric material for a plasma display panel according to the present invention, a high-strength glass plate for a plasma display panel can be obtained. In addition, for example, even when a dielectric layer is formed, using the dielectric material for a plasma display panel according to the present invention, on a substrate with electrodes formed thereon so that the resulting dielectric layer adjoins the electrodes, the dielectric layer is less likely to cause a color change due to reaction with the electrodes.

### DESCRIPTION OF EMBODIMENTS

In plasma display panels in which no protective plate is formed on the outside surface of the front glass substrate, the following can be considered as one of causes of breakage of the front glass substrate due to application of an impact. When an impact is given to the front glass substrate, the transparent dielectric of the front glass substrate and the partitions on the rear glass substrate hit each other. At this time, the partitions create origins serving as starting points of breakage in the transparent dielectric. Cracks develop from the origins to the entire front glass substrate. It can be considered that as a result the front glass substrate is broken.

Therefore, in order to prevent a plasma display panel having no protective plate from causing breakage of the front glass substrate, it can be considered effective to increase the strength of the dielectric layer to be formed on the front glass substrate.

The dielectric material for a plasma display panel according to the present invention contains ZnO—B₂O₂—SiO₂-based nonlead glass powder. ZnO—B₂O₂—SiO₂-based nonlead glasses have low melting points although they contain no PbO. In addition, ZnO—B₂O₂—SiO₂-based nonlead glasses can be easily given a coefficient of thermal expansion approximating that of the glass substrate. Furthermore, the glass powder contained in the dielectric material for a plasma display panel according to the present invention contains, by mole percent, more than 42% SiO₂ and 26% or more B₂O₃ which are components for forming the glass network to increase the strength of the dielectric layer (fired glass film). In addition, in the glass powder contained in the dielectric material for a plasma display panel according to the present invention, the contents of ZnO and Bi₂O₂, which are components that relax the glass network to lower the strength of the dielectric layer, are restricted to up to 20% and up to 5%, respectively, by mole percent. Therefore, when a dielectric layer is formed on the glass substrate using the dielectric material for a plasma display panel according to the present invention, a high-strength glass plate for a plasma display panel can be obtained.

The glass powder contained in the dielectric material for a plasma display panel according to the present invention also contains, by mole percent, 1% to 20% (both inclusive) ZnO, 26% to 50% (both inclusive) B₂O₃, 42% (exclusive) to 50% (inclusive) SiO₂, and 0.1% to 5% (both inclusive) Bi₂O₃. Therefore, the dielectric material for a plasma display panel according to the present invention can be fired at a low temperature, for example, at 600° C. or below. With the use of the dielectric material for a plasma display panel according to the present invention, a dielectric layer can be formed which has a coefficient of thermal expansion approximating that of the glass substrate. In addition, with the use of the dielectric material for a plasma display panel according to the present invention, a glass substrate is less likely to cause warpage when a dielectric layer is formed on the glass substrate by firing.

The glass powder contained in the dielectric material for a plasma display panel according to the present invention preferably also contains, by mole percent, 1% to 12% (both inclusive) Na₂₀, 1% to 15% (both inclusive) K₂O and 0.01% to 6% (both inclusive) CuO+MoO₃+CeO₂+MnO₂+CoO, and the content of Na₂O+K₂O by mole percent is preferably 5% to 20%, both inclusive.

Furthermore, in the glass powder contained in the dielectric material for a plasma display panel according to the present invention, the molar ratio of ZnO to Bi₂O₃ (ZnO/Bi₂O₃) is preferably between 1 and 6.5, both inclusive.

The reasons why the glass powder composition is restricted as described above in the present invention are as follows.

ZnO is a component for lowering the glass softening point. The content of ZnO is 1% to 20% (both exclusive) by mole percent. If the content of ZnO is too small, the softening point of the glass powder rises, which may make it difficult to fire the dielectric material for a plasma display panel at a low temperature, for example, at 600° C. or below. In addition, if the content of ZnO is too small, the coefficient of thermal expansion of the dielectric layer formed of the dielectric material for a plasma display panel tends to become larger than that of the glass substrate, which may result in an excessively large difference in coefficient of thermal expansion between the dielectric layer and the glass substrate. On the other hand, if the content of ZnO is large, the glass network relaxes to lower the strength of the dielectric layer, which makes it difficult to obtain a glass plate for a plasma display panel having high strength. The preferred range of ZnO contents is 5% to 20% (both inclusive) by mole percent, the more preferred range thereof is 10% to 20% (both inclusive) by mole percent, and the still more preferred range thereof is 10% to 13% (both inclusive) by mole percent.

B₂O₃ is a component for forming the glass network. The content of B₂O₃ is 26% to 50% (both inclusive) by mole percent. If the content of B₂O₃ is small, the glass network relaxes to lower the strength of the dielectric layer, which makes it difficult to obtain a glass plate for a plasma display panel having high strength. On the other hand, if the content of B₂O₃ is large, the glass softening point tends to rise, which may make it difficult to fire the dielectric material for a plasma display panel at a low temperature, for example, at 600° C. or below. In addition, if the content of B₂O₃ is large, the glass weatherability is likely to become deteriorated. The preferred range of B₂O₃ contents is 29% to 47% (both inclusive) by mole percent, the more preferred range thereof is 30% to 44% (both inclusive) by mole percent, and the still more preferred range thereof is 30% to 32% (both inclusive) by mole percent.

SiO₂ is a component for forming the glass network. The content of SiO₂ is 42% (exclusive) to 50% (inclusive) by mole percent. If the content of SiO₂ is small, the glass network relaxes to lower the strength of the dielectric layer, which makes it difficult to obtain a glass plate for a plasma display panel having high strength. On the other hand, if the content of SiO₂ is large, the softening point of the glass powder tends to rise, which may make it difficult to fire the dielectric material for a plasma display panel at a low temperature, for example, at 600° C. or below. In addition, if the content of SiO₂ is large, the coefficient of thermal expansion of the dielectric layer formed of the dielectric material for a plasma display panel may become much smaller than that of the glass substrate. Thus, when the dielectric layer is fired on the glass substrate, the glass substrate may be easily warped. The preferred range of SiO₂ contents is 42.5% to 49% (both inclusive) by mole percent, and the more preferred range thereof is 43% to 48% (both inclusive) by mole percent.

Bi₂O₂ is a component for lowering the glass softening point. The content of Bi₂O₂ is 0.1% to 5% (both inclusive) by mole percent. If the content of Bi₂O₂ is small, the softening point of the glass powder tends to rise, which may make it difficult to fire the dielectric material for a plasma display panel at a low temperature, for example, at 600° C. or below. In addition, if the content of Bi₂O₃ is small, because of the tendency towards a rise in the softening point of the glass, the content of alkali metal oxide must be increased by an amount equivalent to the reduced content of Bi₂O₂ in order to obtain low-softening-point glass powder. If the content of alkali metal oxide is increased, however, the dielectric layer easily reacts with Ag or the like contained in the electrodes, for example, when the dielectric layer adjoins the electrodes. If the dielectric layer reacts with Ag or the like contained in the electrodes, the dielectric layer is likely to be changed in color (turned yellow). Therefore, a problem easily arises of difficulty in recognizing the produced image. On the other hand, if the content of Bi₂O₃ is large, the glass network relaxes, whereby the strength of the dielectric layer tends to drop. Therefore, it becomes difficult to obtain a glass plate for a plasma display panel having high strength. In addition, if the content of Bi₂O₃ is large, the cost for the glass plate for a plasma display panel significantly rises. The preferred range of Bi₂O₃ contents is 0.5% to 4.5% (both inclusive) by mole percent, the more preferred range thereof is 1% to 4% (both inclusive) by mole percent, and the still more preferred range thereof is 1.8% to 4% (both inclusive) by mole percent.

Note that the (ZnO/Bi₂O₃) which is the molar ratio between ZnO and Bi₂O₃ is preferably in the range of 1 to 6.5, both inclusive. In this case, the softening point of the glass powder can be lowered without much reduction in the strength of the resulting dielectric layer. Therefore, a dielectric material for a plasma display panel can be achieved which can be fired at a low temperature and by which a high-strength dielectric layer can be formed. If the value of ZnO/Bi₂O₃ is too small, the strength of the dielectric layer tends to significantly drop, which makes it difficult to obtain a glass plate for a plasma display panel having high strength. On the other hand, if the value of ZnO/Bi₂O₃ is too large, the softening point of the glass powder may become too high. Therefore, the content of alkali metal oxide must be increased in order to lower the softening point of the glass powder. If the content of alkali metal oxide is increased, however, the dielectric layer easily reacts with Ag or the like contained in the electrodes, for example, when the dielectric layer adjoins the electrodes. If the dielectric layer reacts with Ag or the like contained in the electrodes, the dielectric layer is likely to be changed in color (turned yellow). Therefore, a problem easily arises of difficulty in recognizing the produced image. The preferred range of ZnO/Bi₂O₃ is 1.5 to 5.0, both inclusive, and the more preferred range thereof is 2.5 to 5, both inclusive.

Na₂O is a component for lowering the glass softening point. Na₂O is also a component for adjusting the coefficient of thermal expansion. The content of Na₂O is preferably 1% to 12% (both inclusive) by mole percent. If the content of Na₂O is small, the softening point of the glass powder rises, which makes it difficult to fire the dielectric material for a plasma display panel at a low temperature, for example, at 600° C. or below. On the other hand, if the content of Na₂O is large, the dielectric layer, if adjoining the electrodes, tends to react with Ag or the like contained in the electrodes and thereby be easily changed into yellow (turned yellow). Therefore, a problem easily arises of difficulty in recognizing the produced image. In addition, if the content of Na₂O is large, the coefficient of thermal expansion of the dielectric layer tends to become larger than that of the glass substrate, which may result in an excessively large difference in coefficient of thermal expansion between the dielectric layer and the glass substrate. The preferred range of Na₂O contents is 1% to 10% (both inclusive) by mole percent, the more preferred range thereof is 1% to 8% (both inclusive) by mole percent, and the still more preferred range thereof is 2% to 6% (both inclusive) by mole percent.

K₂O is a component for lowering the glass softening point. K₂O is also a component for adjusting the coefficient of thermal expansion. The content of K₂O is preferably 1% to 15% (both inclusive) by mole percent. If the content of K₂O is small, the softening point of the glass powder rises, which makes it difficult to fire the dielectric material for a plasma display panel at a low temperature, for example, at 600° C. or below. On the other hand, if the content of K₂O is large, the dielectric layer, if adjoining the electrodes, tends to react with Ag or the like contained in the electrodes and thereby be easily changed into yellow (turned yellow). Therefore, a problem easily arises of difficulty in recognizing the produced image. In addition, if the content of K₂O is large, the coefficient of thermal expansion of the dielectric layer tends to become larger than that of the glass substrate, which may result in an excessively large difference in coefficient of thermal expansion between the dielectric layer and the glass substrate. The preferred range of K₂O contents is 1% to 14% (both inclusive) by mole percent, the more preferred range thereof is 4% to 12% (both inclusive) by mole percent, and the still more preferred range thereof is 6% to 8% (both inclusive) by mole percent.

Note that in order to prevent yellowing of the dielectric layer due to reaction with Ag or the like contained in the electrodes if the electrodes adjoin the dielectric layer, allow the dielectric material for a plasma display panel to be fired at a low temperature, for example, 600° C. or below, and allow the dielectric layer to be formed to have a coefficient of thermal expansion approximating that of the glass substrate, the total content of Na₂O and K₂O (Na₂O+K₂O) is preferably 5% to 20% (both inclusive) by mole percent. If the content of Na₂O+K₂O is small, the softening point of the glass powder rises, which makes it difficult to fire the dielectric material for a plasma display panel at a low temperature, for example, at 600° C. or below. On the other hand, if the content of Na₂O+K₂O is large, the dielectric layer, if adjoining the electrodes, tends to react with Ag or the like contained in the electrodes and thereby be easily turned yellow. Therefore, a problem easily arises of difficulty in recognizing the produced image. In addition, if the content of Na₂O+K₂O is large, the coefficient of thermal expansion of the dielectric layer tends to become larger than that of the glass substrate, which may result in an excessively large difference in coefficient of thermal expansion between the dielectric layer and the glass substrate. The preferred range of contents of Na₂O+K₂O is 6% to 18% (both inclusive) by mole percent, the more preferred range thereof is 8% to 15% (both inclusive) by mole percent, and the still more preferred range thereof is 8% to 12% (both inclusive) by mole percent.

Note that in forming the dielectric layer to adjoin the electrodes, in order to prevent color change of the dielectric layer due to reaction between the dielectric layer and Ag or the like contained in the electrodes, the glass powder preferably also contains CuO, MoO₃, CeO₂, MnO₂ and CoO, in addition to the above components, so that the total content of CuO, MoO₃, CeO₂, MnO₂ and CoO (CuO+MoO₃+CeO₂+MnO₂+CoO) is 0.01% to 6% (both inclusive) by mole percent. If the content of CuO+MoO₃+CeO₂+MnO₂+CoO is small, the dielectric layer may be easily changed in color. On the other hand, if the content of CuO+MoO₃+CeO₂+MnO₂+CoO is large, light absorption of these components themselves may easily cause the dielectric layer to become tinted. The preferred range of contents of CuO+MoO₃+CeO₂+MnO₂+CoO is 0.01% to 5% (both inclusive) by mole percent, and the more preferred range thereof is 0.01% to 3% (both inclusive) by mole percent.

Note that among CuO, MoO₃, CeO₂, MnO₂ and CoO, CuO has the largest effect of preventing color change of the dielectric layer. Therefore, it is more preferred that CuO should be an essential component. In this case, the content of CuO is preferably 0.01% to 3.0% (both inclusive) by mole percent, and more preferably 0.02% to 2.5% (both inclusive) by mole percent. The content of each of MoO₃, CeO₂, MnO₂ and CoO is preferably 0% to 5% (both inclusive) by mole percent, and more preferably 0.01% to 3% (both inclusive) by mole percent.

Furthermore, the dielectric material for a plasma display panel according to the present invention may contain, aside from the above components, various other components so long as they do not impair required properties. For example, the glass powder contained in the dielectric material for a plasma display panel preferably contains MgO, CaO, SrO, BaO and TiO₂ so that the total content of MgO, CaO, SrO, BaO and TiO₂ (MgO+CaO+SrO+BaO+TiO₂) is 0% to 15% (both inclusive) by mole percent. If the glass powder contains at least one of MgO, CaO, SrO, BaO and TiO₂, the softening point of the glass powder can be lowered. In addition, the coefficient of thermal expansion of the dielectric layer can be adjusted.

Furthermore, the glass powder contained in the dielectric material for a plasma display panel preferably contains Cs₂O and Rb₂O so that the total content of Cs₂O and Rb₂O (Cs₂O+Rb₂O) is 0% to 10% (both inclusive) by mole percent. If the glass powder contains at least one of Cs₂O and Rb₂O, the softening point of the glass powder can be lowered.

Moreover, the glass powder contained in the dielectric material for a plasma display panel preferably contains Al₂O₃, ZrO₂, Y₂O₃, La₂O₃, Ta₂O₅, SnO₂, WO₃, Nb₂O₅, Sb₂O₅ and P₂O₅ so that the total content of Al₂O₃, ZrO₂, Y₂O₃, La₂O₃, Ta₂O₅, SnO₂, WO₃, Nb₂O₅, Sb₂O₅ and P₂O₅ (Al₂O₃+ZrO₂+Y₂O₃+La₂O₃+Ta₂O₅+SnO₂+WO₃+Nb₂O₅+Sb₂O₃+P₂O₃) is 0% to 10% (both inclusive) by mole percent. If the glass powder contains at least one of Al₂O₃, ZrO₂, Y₂O₃, La₂O₃, Ta₂O₅, SnO₂, WO₃, Nb₂O₅, Sb₂O₅ and P₂O₅, the glass can be stabilized and the water resistance or acid resistance of the glass powder can be increased.

Furthermore, the glass powder contained in the dielectric material for a plasma display panel may contain P₂O₅ within the range of 0% to 6% (both inclusive) by mole percent.

The glass powder contained in the dielectric material for a plasma display panel according to the present invention contains substantially no PbO which is a substance of environmental concern.

Note that “contain substantially no” herein means that the component is not positively used as a raw material but is contained in the glass powder only to an extent that it is mixed as an impurity thereinto, and more specifically means that the content of the component is 0.1% or less by mole percent.

The particle size of the glass powder in the dielectric material for a plasma display panel according to the present invention is preferably 3.0 μm or less in average particle diameter D₅₀ and 20 μm or less in maximum particle diameter Dₘₐₓ. If the particle size of the glass powder is too large, big bubbles are likely to be left in the resulting dielectric layer, which makes it difficult to obtain a dielectric layer having a stable withstand voltage.

The dielectric material for a plasma display panel according to the present invention may contain, in addition to the above glass powder, ceramic powder in order to adjust the coefficient of thermal expansion, the strength, the appearance and other properties of the dielectric layer. If the content of ceramic powder is too large, the sintering cannot adequately be achieved, which may make it difficult to form a dense film. Note that a material that can be used as ceramic powder is, for example, one or more kinds of ceramic powders including alumina, zirconia, zircon, titania, cordierite, mullite, silica, willemite, tin oxide and zinc oxide. Furthermore, from the viewpoint of preventing degradation in transparency of the dielectric layer, some or all of the ceramic powder particles are preferably spherical. The term “spherical” used herein means the shape that, through photographic observation of the state, has no angular portion on the particle surface and has a variation of ±20% or below in radius from the particle center to every point on the surface. Moreover, the preferred ceramic powder to be used is one having an average particle diameter of 5.0 μm or less and a maximum particle diameter of 20 μm or less.

Note that the dielectric material for a plasma display panel according to the present invention can be used in both applications of a transparent dielectric layer for a front glass substrate and an address electrode-protecting dielectric layer for a rear glass substrate. Furthermore, the dielectric material for a plasma display panel according to the present invention can be used, in a multilayer dielectric formed of two or more dielectric layers, as a material for a lower dielectric layer in contact with the electrodes or as a material for an upper dielectric layer formed on a lower dielectric layer and not in direct contact with the electrodes. Naturally, the dielectric material for a plasma display panel according to the present invention can also be used for a dielectric layer formed on electrodes containing no Ag or for formation of other members. The dielectric material for a plasma display panel according to the present invention can also be used as a partition-forming material for forming partitions in a plasma display panel.

If the dielectric material for a plasma display panel according to the present invention is used as a transparent dielectric material, the content of the above ceramic powder is preferably 0% by mass to 20% by mass, both inclusive, and more preferably 0% by mass to 10% by mass, both inclusive. If the content of the ceramic powder is as above, the increase in scattering of visible light due to doping with the ceramic powder can be suppressed, thereby obtaining a fired dielectric film having a high transparency.

Furthermore, if the dielectric material for a plasma display panel according to the present invention is used as a dielectric material for protecting the address electrodes or a material for partitions, the content of the above ceramic material is preferably 0% by mass to 50% by mass, both inclusive, more preferably 5% by mass to 40% by mass, both inclusive, and still more preferably 10% by mass to 40% by mass, both inclusive. If the content of the ceramic material is as above, there can be obtained a fired dielectric film having high strength or excellent acid resistance.

Next, a description will be given of an example of a method for using the dielectric material for a plasma display panel according to the present invention. The dielectric material for a plasma display panel according to the present invention can be used, for example, in paste or green sheet form.

In using the dielectric material for a plasma display panel in paste form, a paste is formed by adding to the above dielectric material a thermoplastic resin, a plasticizer, a solvent and the like. Note that the proportion of the whole paste accounted for by the dielectric material is generally about 30% by mass to about 90% by mass.

The thermoplastic resin is a component for increasing the strength of the film after being dried and giving the film flexibility. The content of the thermoplastic resin is preferably about 0.1% by mass to about 20% by mass. Examples of the thermoplastic resin that can be used include polybutyl methacrylate, polyvinyl butyral, polymethyl methacrylate, polyethyl methacrylate, and ethyl cellulose. These resins can be used singularly or as a mixture.

The plasticizer is a component for controlling the drying speed and giving the dried film flexibility. The content of the plasticizer is preferably about 0% by mass to about 10% by mass. Examples of the plasticizer that can be used include butyl benzyl phthalate, dioctyl phthalate, diisooctyl phthalate, dicapryl phthalate and dibutyl phthalate. These plasticizers can be used singularly or as a mixture.

The solvent is an agent for making materials into paste form. The content of the solvent is preferably about 10% by mass to about 30% by mass. Examples of the solvent include terpineol, diethylene glycol monobutyl ether acetate and 2,2,4-trimethyl-1,3-pentadiol monoisobutyrate, and these solvents can be used singularly or as a mixture.

The production of the paste can be implemented by preparing the above dielectric material, thermoplastic resin, plasticizer, solvent and the like and kneading them in a predetermined ratio.

In order to form a dielectric layer using such a paste, the paste is first applied onto a glass substrate with electrodes formed thereon, such as by screen printing or batch coating, thereby forming a coated layer having a predetermined film thickness. The coated layer is then dried. Thereafter, the coated layer is fired while being held at a temperature of 500° C. to 600° C. for 5 to 20 minutes, whereby a predetermined dielectric layer can be obtained. Note that if the firing temperature is too low or the holding time is short, the sintering cannot adequately be achieved, which makes it difficult to form a dense film. On the other hand, if the firing temperature is too high or the holding time is long, the glass substrate is likely to become deformed or the dielectric layer is likely to be changed in color owing to reaction with the electrodes.

Note that in forming a multilayer dielectric formed of two or more dielectric layers, a paste for forming a lower dielectric layer is applied onto a glass substrate, on which electrodes are previously formed, such as by screen printing or batch coating to give a film thickness of approximately 20 μm to 80 μm, dried and then fired in the same manner as described above. Subsequently, a paste for forming an upper dielectric layer is applied onto the lower dielectric layer, such as by screen printing or batch coating to give a film thickness of approximately 60 μm to 160 μm and dried. Thereafter, the paste is fired in the same manner as described above, whereby a multilayer dielectric can be obtained.

In using the material of the present invention in green sheet form, a green sheet is formed by adding to the above dielectric material a thermoplastic resin, a plasticizer and the like. Note that the proportion of the green sheet accounted for by the dielectric material is preferably about 60% by mass to about 80% by mass.

Examples of the thermoplastic resin and the plasticizer that can be used are the same as those used in preparing the paste. The mixture ratio of the thermoplastic resin is preferably about 5% by mass to about 30% by mass. The mixture ratio of the plasticizer is preferably about 0% by mass to about 10% by mass.

The production of the green sheet can be implemented by general methods. In an example of such a general method, the above dielectric material, thermoplastic resin, plasticizer and the like are prepared, a prime solvent, such as toluene, and an auxiliary solvent, such as isopropyl alcohol, are added to the prepared materials to form a slurry, and the slurry is formed into a sheet on a film made of polyethylene terephthalate (PET) or the like, such as by a doctor blade method. After the formation of the sheet, the sheet is dried to remove the solvents, whereby a green sheet can be provided.

In forming a dielectric layer using a green sheet obtained in the above manner, a green sheet is placed on a glass substrate on which electrodes are formed, bonded by thermocompression to form a coated layer, and fired in the same manner as in the case of the paste, whereby a dielectric layer can be obtained.

Note that in forming a multilayer dielectric formed of two or more dielectric layers, a green sheet for forming a lower dielectric layer is bonded by thermocompression onto a glass substrate, on which electrodes are previously formed, to form a lower dielectric film, and then fired in the same manner as in the case of the above paste. Subsequently, a green sheet for forming an upper dielectric layer is bonded by thermocompression onto the lower dielectric layer to form an upper dielectric film. Thereafter, the upper dielectric film is fired in the same manner as described above, whereby a multilayer dielectric can be obtained.

In forming a multilayer dielectric formed of two or more dielectric layers, regardless of which of the paste and the green sheet is used, the material for an upper dielectric layer is preferably fired in the temperature range from 20° C. lower than the temperature for firing the lower dielectric layer to 20° C. higher than the temperature. Thus, yellowing of the dielectric layer due to Ag or the like contained in the electrodes can be prevented, and bubbling at the interface between the lower and upper dielectric layers can be prevented while the shape of the lower dielectric layer is maintained. If the firing temperature for the dielectric material used to form an upper dielectric layer is the same as that for the dielectric material used to form a lower dielectric layer, besides the above formation method, another method can be used in which after the drying of a lower dielectric film, an upper dielectric film is then formed and dried and both the layers are then simultaneously fired at a predetermined temperature.

Alternatively, a hybrid formation method can be used in which a lower dielectric layer is formed using a paste and an upper dielectric layer is formed using a green sheet.

Since, as described so far, the dielectric material according to the present invention is applied or placed on a glass substrate on which electrodes are formed, and the dielectric material is fired to form a dielectric layer, there can be obtained a glass plate for a plasma display panel which gives less color change of the dielectric layer caused by Ag or the like contained in the electrodes and has excellent transparency.

The above description has been given taking as an example of the method for forming a dielectric layer a method using a paste or a green sheet. However, the method for forming a dielectric layer in the present invention is not limited to the above method. The dielectric layer can also be formed by other formation methods, such as a photosensitive paste process or a photosensitive green sheet process.

### EXAMPLES

Hereinafter, the dielectric material for a plasma display according to the present invention will be described in detail with reference to Examples.

Tables 1 and 2 show examples of the present invention (Samples Nos. 1 to 9) and comparative examples (Samples Nos. 10 and 11).

TABLE 1

| | Examples | | | | | |
|---|---|---|---|---|---|---|
| | No. 1 | No. 2 | No. 3 | No. 4 | No. 5 | No. 6 |
| Glass | | | | | | |
| Composition | | | | | | |
| (% by mole) | | | | | | |
| ZnO | 12.5 | 11.0 | 10.0 | 12.0 | 10.1 | 11.0 |
| B₂O₃ | 30.0 | 31.0 | 30.5 | 31.0 | 32.0 | 31.0 |
| SiO₂ | 43.0 | 44.0 | 44.2 | 43.0 | 44.5 | 43.0 |
| Bi₂O₃ | 3.5 | 3.5 | 4.0 | 0.5 | 1.9 | 3.0 |
| Al₂O₃ | 0.5 | — | — | 1.0 | — | 0.5 |
| Na₂O | 3.0 | 2.0 | 4.0 | 6.0 | 2.0 | 4.0 |
| K₂O | 6.5 | 8.0 | 7.0 | 6.0 | 7.0 | 7.0 |
| BaO | — | — | — | — | 2.0 | — |
| TiO₂ | — | 0.2 | — | — | — | — |
| CuO | 1.0 | 0.3 | 0.2 | 0.5 | 0.5 | 0.5 |
| CoO | — | — | 0.1 | — | — | — |
| ZnO/Bi₂O₃ | 3.57 | 3.14 | 2.50 | 24.00 | 5.32 | 3.67 |
| Softening | 595 | 590 | 590 | 585 | 590 | 585 |
| Point (° C.) | | | | | | |
| CTE | 74 | 74 | 77 | 78 | 78 | 77 |
| (×10⁻⁷/° C.) | | | | | | |
| Dielectric | 7.2 | 7.2 | 7.6 | 6.7 | 6.7 | 6.8 |
| Constant | | | | | | |
| Deg. of | +3.6 | +4.3 | +2.0 | +9.2 | +4.1 | +5.6 |
| Yellowing [b*] | | | | | | |
| Strength (cm) | 17 | 18 | 16 | 18 | 18 | 17 |

TABLE 2

| | Examples | | | Comp. Examples | |
|---|---|---|---|---|---|
| | No. 7 | No. 8 | No. 9 | No. 10 | No. 11 |
| Glass Composition | | | | | |
| (% by mole) | | | | | |
| ZnO | 10.0 | 11.7 | 13.0 | 21.0 | 11.0 |
| B₂O₃ | 30.0 | 30.0 | 30.5 | 34.0 | 36.5 |
| SiO₂ | 46.0 | 48.0 | 43.0 | 24.4 | 40.5 |
| Bi₂O₃ | 2.0 | 1.8 | 3.5 | 5.5 | — |
| Al₂O₃ | — | — | 0.5 | 4.5 | 1.0 |
| Na₂O | 2.0 | 2.0 | 3.0 | 2.0 | 3.0 |
| K₂O | 7.5 | 6.0 | 6.5 | 6.0 | 7.5 |
| BaO | 2.0 | — | — | 2.0 | — |
| TiO₂ | — | — | — | — | — |
| CuO | 0.5 | 0.45 | — | 0.5 | 0.5 |
| CoO | — | 0.05 | — | 0.1 | — |
| ZnO/Bi₂O₃ | 5.00 | 6.50 | 3.71 | 3.82 | — |
| Softening Point (° C.) | 590 | 600 | 595 | 585 | 595 |
| CTE (×10⁻⁷/° C.) | 76 | 74 | 74 | 80 | 70 |
| Dielectric Constant | 7.3 | 7.0 | 7.0 | 10.5 | 6.4 |
| Deg. of Yellowing [b *] | +4.4 | +4.0 | +9.9 | +4.0 | +3.3 |
| Strength (cm) | 18 | 20 | 17 | 9 | 16 |

The individual samples in the above tables were prepared in the following manner.

First, raw materials were compounded to provide the individual glass composition shown in mole percent (% by mole) in Tables 1 to 4 and homogeneously mixed. Next, the material mixture was put into a platinum crucible and melted therein at 1300° C. for 2 hours, and the molten glass was formed into a thin plate. Subsequently, the obtained thin glass plate was ground into particles with a ball mill and the particles were air classified, thereby obtaining a sample made of glass powder having an average particle diameter D₅₀ of 3.0 μm or less and a maximum particle diameter Dₘₐₓ of 20 μm or less. Each glass powder sample thus obtained was evaluated in terms of softening point, coefficient of thermal expansion and dielectric constant.

Next, the above glass powder sample was mixed with a terpineol solution containing 5% ethyl cellulose, and the mixture was kneaded into paste form with a triple-roll mill. Subsequently, the paste was applied onto two glass substrates, on which Ag electrodes were formed, by screen printing so that approximately 25 μm thick fired films could be obtained, and the paste-coated glass substrates were dried and then fired in an electric furnace while being held, one at 600° C. and the other at 620° C., for 10 minutes to form dielectric layers, thereby obtaining two glass substrate samples. Each glass substrate sample thus obtained was evaluated in terms of degree of yellowing and variation in yellowing prevention effect due to change in firing condition. Furthermore, the glass substrate sample obtained by firing at 600° C. was evaluated in terms of strength. The Ag electrodes and glass substrate used were H-4040A manufactured by Shoei Chemical Inc. and PP-8 having a thickness of 1.8 mm and a size of 5 cm by 5 cm and manufactured by Nippon Electric Glass Co., Ltd., respectively.

As is evident from Tables 1 and 2, Samples Nos. 1 to 9, which are inventive examples, exhibited glass softening points not higher than 600° C., and therefore can adequately be fired at a temperature of 600° C. or below. The coefficients of thermal expansion of these samples were within the range of 74×10⁻⁷/° C. to 78×10⁻⁷/° C. and approximated the coefficient of thermal expansion of the glass substrate (about 83×10⁻⁷/° C.). Even when the dielectric layer was formed on each glass substrate, the glass substrate was not warped during firing. The dielectric constants of Samples Nos. 1 to 9 were 7.6 or below. Furthermore, in Samples Nos. 1 to 9, the values b* were +9.9 or less, and substantially no yellowing of the dielectric layer due to reaction with the Ag electrodes was observed. Moreover, in Samples Nos. 1 to 9, their strengths under a steel ball falling test were 16 cm or more. This shows that Samples Nos. 1 to 9 has high strength.

Note that as for Sample No. 4, the value of ZnO/Bi₂O₃ was as large as 24.0 and a large amount of alkali metal oxide component was therefore contained in the sample to lower the softening point, whereby the value b* was +9.2 or more and the degree of yellowing was high compared to those of some other inventive examples. Furthermore, Sample No. 9 contained no component for preventing color change of the dielectric layer due to reaction with Ag. Therefore, its value b* was +9.2 or more and the degree of yellowing was higher than those of the other inventive examples.

In contrast, Sample No. 10, which is a comparative example, exhibited a strength of 9 cm under a steel ball falling test. This shows that Sample No. 10 has low strength. Furthermore, the strength of Sample No. 11 under a steel ball falling test was 16 cm. Therefore, Sample No. 11 has a high strength. However, the coefficient of thermal expansion of the dielectric layer in this sample was as low as 70×10⁻⁷/° C. and a compressive stress was formed on the dielectric layer side. Therefore, it can be expected that if a dielectric layer is formed from this sample on a large-size glass substrate, the glass substrate will be warped during firing.

Note that the glass softening point was measured with a macro differential thermal analyzer and the value of the fourth inflection point was considered as the softening point.

As for the coefficient of thermal expansion of glass, each glass powder sample was subjected to powder pressing into a body and the body was fired at 600° C. for 10 minutes, polished into the shape of a column having a diameter of 4 mm and a length of 20 mm and measured in terms of coefficient of thermal expansion in the temperature range of 30° C. to 300° C. in accordance with JIS R3102.

Note that the coefficient of thermal expansion of glass substrate used for plasma display panel is about 83×10⁻⁷/° C. Therefore, if the coefficient of thermal expansion of the dielectric material is any value from 73×10⁻⁷/° C. to 83×10⁻⁷/° C. which approximates that of the glass substrate used, the glass substrate is not warped during firing even if a dielectric layer is formed on the glass substrate.

As for the dielectric constant, each sample was subjected to powder pressing into a body and the body was fired at 600° C. for 10 minutes, polished into a 2 mm thick plate and measured in terms of dielectric constant at 25° C. and 1 MHz in accordance with JIS C2141.

As for the degree of yellowing, the color characteristic of each dielectric layer was measured and evaluated in terms of value b* with a colorimeter. Note that a greater value b* implies that the dielectric layer is turned yellower.

The strength was evaluated using a steel ball falling test. Specifically, each glass substrate was placed on a waterproof abrasive paper (#1000) to adjoin the paper at the surface on which the dielectric layer was formed, a SUS steel ball (14 g) was dropped on the glass substrate at different heights in increments of 1 cm, and the height at which the glass substrate was broken was evaluated. Note that the test was conducted ten times for each sample and the average value of the measurement results is shown as a strength of the sample.

1. A dielectric material for a plasma display panel containing ZnO—B₂O₃—SiO₂-based glass powder, the glass powder containing substantially no PbO and contains, by mole percent, 1% to 20% (both inclusive) ZnO, 26% to 50% (both inclusive) B₂O₃, 42% (exclusive) to 50% (inclusive) SiO₂, and 0.1% to 5% (both inclusive) Bi₂O₃.

2. The dielectric material for a plasma display panel according to claim 1, wherein the glass powder further contains, by mole percent, 1% to 12% (both inclusive) Na₂O, 1% to 15% (both inclusive) K₂O and 0.01% to 6% (both inclusive) CuO+MoO₃+CeO₂+MnO₂+CoO, and the content of Na₂O+K₂O by mole percent is 5% to 20%, both inclusive.

3. The dielectric material for a plasma display panel according to claim 1, the dielectric material being used to form a dielectric layer adjoining Ag electrodes formed on a glass substrate.

4. The dielectric material for a plasma display panel according to claim 1, the dielectric material being used as a transparent dielectric material for a front glass substrate.

5. The dielectric material for a plasma display panel according to claim 1, wherein the content of ZnO in the glass powder is 10% to 13%, both inclusive, by mole percent.

6. The dielectric material for a plasma display panel according to claim 1, wherein the content of B₂O₃ in the glass powder is 30% to 32%, both inclusive, by mole percent.

7. The dielectric material for a plasma display panel according to claim 1, wherein the content of SiO₂ in the glass powder is 43% to 48%, both inclusive, by mole percent.

8. The dielectric material for a plasma display panel according to claim 1, wherein the content of Bi₂O₃ in the glass powder is 1% to 4%, both inclusive, by mole percent.

9. The dielectric material for a plasma display panel according to claim 8, wherein the content of Bi₂O₃ in the glass powder is 1.8% to 4%, both inclusive, by mole percent.

10. The dielectric material for a plasma display panel according to claim 1, wherein the content of Na₂O in the glass powder is 2% to 6%, both inclusive, by mole percent.

11. The dielectric material for a plasma display panel according to claim 1, wherein the content of K₂O in the glass powder is 6% to 8%, both inclusive, by mole percent.

12. The dielectric material for a plasma display panel according to claim 1, wherein the content of Na₂O+K₂O in the glass powder is 8% to 12%, both inclusive, by mole percent.

13. The dielectric material for a plasma display panel according to claim 1, wherein the content of CuO+MoO₃+CeO₂+MnO₂+CoO is 0.01% to 3%, both inclusive, by mole percent.

14. The dielectric material for a plasma display panel according to claim 1, wherein the molar ratio of ZnO to Bi₂O₃ (ZnO/Bi₂O₃) in the glass powder is between 1 and 6.5, both inclusive.

15. The dielectric material for a plasma display panel according to claim 14, wherein the molar ratio of ZnO to Bi₂O₃ (ZnO/Bi₂O₃) in the glass powder is between 2.5 and 5, both inclusive.

16. A glass plate for a plasma display panel, comprising the dielectric material for a plasma display panel according to claim 1.
